(19) United States
(12) Patent Application Publication
(10) Pub. No.: US 2010/0127567 A1
(43) Pub. Date: May 27, 2010

(54) POWER SAVING GENERAL PURPOSE OUTLET

(76) Inventor: Richard BISINELLA, Victoria (AU)

Correspondence Address: ECKERT SEAMANS CHERIN & MELLOTT, LLC, U.S. STEEL TOWER, 600 GRANT STREET, PITTSBURGH, PA, 15219-2788, US

(21) Appl. No.: 12/622,186

(22) Filed: Nov. 19, 2009

(30) Foreign Application Priority Data
Nov. 21, 2008 (AU) 2008906039
Jul. 7, 2009 (AU) 2009903174

(51) Int. Cl. H02J 3/00

(52) U.S. Cl. 307/29

(57) ABSTRACT

The invention provides an electrical supply system including an electrical power point (10) having at least one power outlet (12) that is selectably connected to at least two power providing circuits (28, 30). The power point (10) including a selector means (26) that is operable to provide the power to the at least one power outlet (12) from one of the at least two power providing circuits 28, 30). The system further includes a controller (42) that controls when power is supplied to one of the two circuits (28, 30) based upon pre-determined criteria.

### FIELD OF THE INVENTION

The present invention relates to a power saving General Purpose Power Outlet (GPO) and in particular to an outlet that can be fed electrical power from at least two independent circuits.

### BACKGROUND OF THE INVENTION

Nowadays the general populace is well aware of the need to conserve energy not only as a cost cutting measure but also due to the need to reduce carbon emissions, something that is taken quite seriously. Whilst the obvious way to conserve electrical energy is to simply switch appliances off, the sheer number of appliances in any home or building makes this impractical and time consuming.

In response to this many appliances have a standby mode. Standby power is power that is used when an appliance is not in full operation but still plugged in and continues to use power pending a future operation or command. An example of this is a television that is switched off by remote control but is waiting for an instruction or command from the remote control or from the television to reactivate.

Whilst the amount of power is generally small, with each appliance operating continuously the total amount of power used is not insubstantial. It is estimated that standby power can equate to up to 10% of the energy consumption of a typical household with an estimated cost to the Australian economy of some $950 million dollars (data obtained from the Sustainable Energy Department office of the Government of Western Australia).

When one considers that most houses are empty for eight to ten hours a day and furthermore the house occupants are asleep for perhaps another six to eight hours, that means that a house is only “lived in” for a period of some six to ten hours.

Given the real and urgent need to reduce carbon emissions and to reduce power consumption the present invention provides a system or a method whereby the reduction of power consumed is achieved by the removal of non-essential consumption or standby power. Obviously the system needs to be adaptable to existing wiring methods, be simple and reliable, and cost effective to allow for market acceptance and the reduction of energy. Some of the appliances that may be prime candidates for such a system include but are not limited to televisions, DVD players, electric kettles, toasters, amplifiers, radios, bathroom appliances, printers, monitors, lamps and so on. Other appliances that one may want to be on all the time would obviously include clocks, refrigerators, and ovens and so on.

Accordingly it is an object of the present invention to overcome the above-mentioned problems or to provide the public with a useful alternative.

### SUMMARY OF THE INVENTION

In a first aspect the invention could be set to reside in an electrical supply system including an electrical power point having at least one power outlet that is selectably connected to at least two power providing circuits, the power point including a selector means that is operable to provide the power to said at least one power outlet from one of the at least two power providing circuits, said system further including a controller that controls when power is supplied to one of the two circuits based upon pre-determined criteria.

In a further form of the invention there is provided an electrical power point having at least one power outlet that is selectably connected to at least two power providing circuits, the power point including a selector means that is operable to provide the power to said at least one power outlet from one of the at least two power providing circuits.

Preferably the power point further includes a power outlet control switch to turn off the power supplied to the said at least one power outlet.

In a still further form of the invention there is provided an electrical power point having two parallel power outlets, both said power outlets fed power from a first or a second power providing circuit depending on the position of a selector switch, the switch in the first position feeding power to the outlets from said first power providing circuit and in a second position feeding power to the outlets from the second power providing circuit.

In a yet further form of the invention there is provided an electrical supply system for providing electrical supply from a first power providing circuit or a second power providing circuit, including:

a user operated selector switch operable between a first position for connecting a power outlet to the first power providing circuit, and a second position for connecting the power outlet to the second power providing circuit.

In a further form of the invention there is provided an electrical supply system including:

a first power providing circuit connected to a first mains electrical supply;

a second power providing circuit connected to a second mains electrical supply;

a user operated first circuit switch operable between a first position for connecting the first mains electrical supply to the first power providing circuit, and a second position for disconnecting the first mains electrical supply from the first power providing circuit; at least one power outlet, and;

a user operated selector switch operable between a first position for connecting said at least one power outlet to the first power providing circuit, and a second position for connecting said at least one power outlet to the second power providing circuit.

In a further form of the invention there is provided an electrical power point having at least one power outlet that is selectably connected to two power providing circuits, the second power providing circuit being derived from the first power providing circuit via a relay, the power point including a selector means that is operable to provide the power to said at least one power outlet from one of the two power providing circuits.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 is a typical General Purpose Power Outlet (GPO) adapted to the present invention and including a power save switch;

FIG. 2 is a schematic diagram illustrating the circuitry of the GPO of FIG. 1;

FIG. 3 illustrates a typical household installation embodying the present invention;

FIG. 4 is a typical circuit diagram illustrating a controller for the present invention;

FIG. 5 is a schematic illustration of the wiring embodying the present invention; and

FIG. 6 illustrates a plurality of circuits embodying the present invention.

FIG. 7 is a schematic diagram illustrating the circuitry of the GPO of FIG. 1 in accordance with a further embodiment of the invention

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

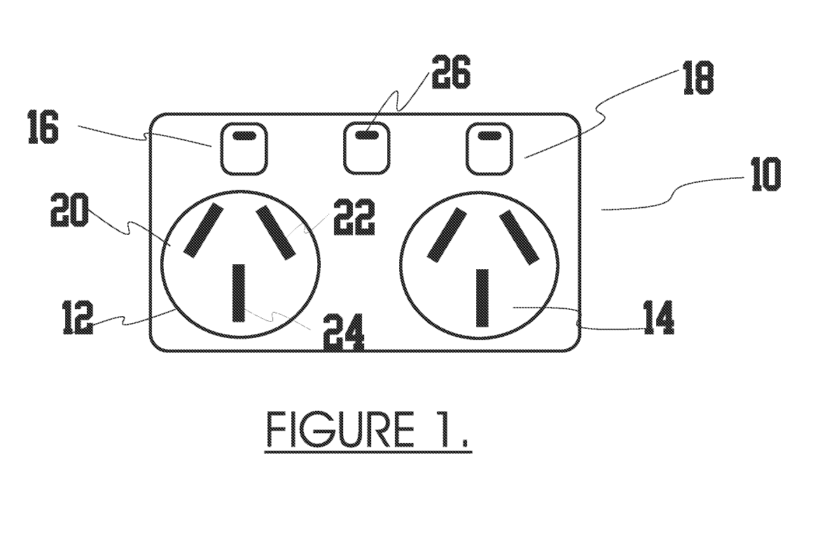

Illustrated in FIG. 1 is a typical GPO 10 embodying the present invention and including two power outlets 12 and 14 operable by respective switches 16 and 18. The power outlets are configured to Australian standards and have three female sockets to accommodate the active wire 20, neutral wire 22 and earth wire 24. However, the present invention is not intended to be limited to just Australian type power outlets and can equally well be applied to power outlets used around the world.

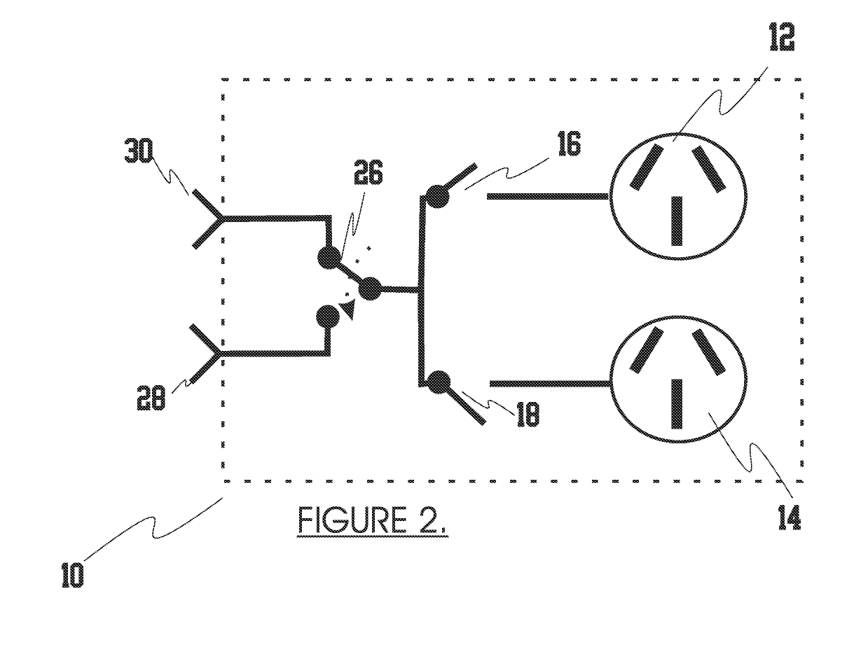

GPO 10 further includes a selector switch 26 that selectively connects the two outlets 12 and 14 to one of two circuits or power inputs, a first mains circuit 28 and a second switched circuit 30, illustrated in FIG. 2. The reader should instantly appreciate the advantage of the present invention. By selecting which power outlets in a house or a building are fed power from one of two circuits, those appliances that do not need to be on all the time can be plugged into the outlets that are fed power from the switched circuit 30 which, as discussed shortly, is turned off at selective times or periods. Typically the power outlets that are connected to the switched circuit are effectively turned off when a house or a building is not being used or after hours.

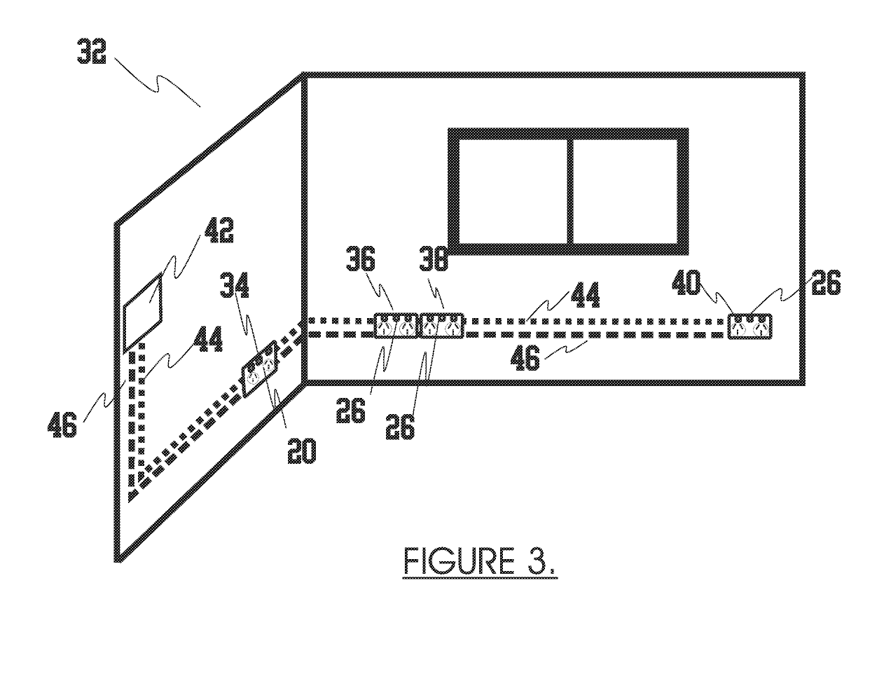

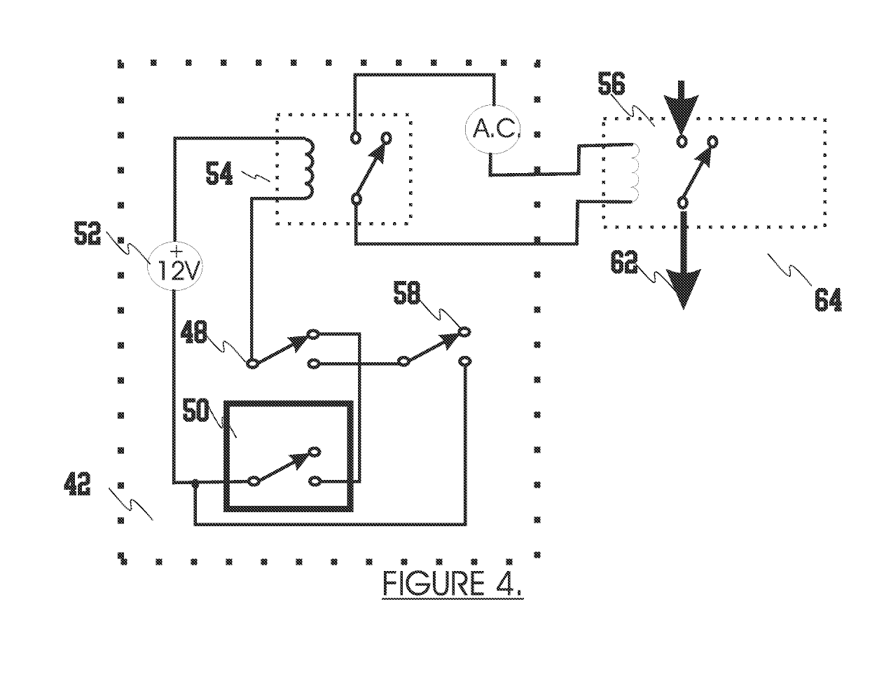

Referring now to FIG. 3, there is illustrated conceptually a building 32 wired according to the present invention and having a plurality of GPO's 34, 36, 38 and 40 disposed in the walls. Extending from a controller 42 are two separate circuits being a mains power circuit 44 and a switched circuit 46, each circuit connected through a 20 power save selector 26 to each GPO. The controller controls if power is fed to the switched circuit. This could be achieved many different ways. For example it could be coupled to an alarm system, as illustrated in FIG. 4. Here the controller 42 turns on and off the switched power 46 to the GPO's. The controller is typically flexible and designed to cater for the building and its use given that an office building would have different requirements to domestic houses. Thus an automatic selector switch 48 enabling the GPO's to be automatically turned on and off when a security system 50 is armed or disarmed. When the alarm is armed and the selector switch on automatic, power is fed from a 12 Volt DC supply 52 to a low voltage relay 54 that activates relay 56 and feeds power from the switched circuit.

Thus the reader will appreciate that in order for the low voltage relay 54 to be activated the security system needs to be disarmed and automatic selector 48 needs to be on automatic mode or the automatic selector 48 needs to be off and the manual switch 58 needs to be switched to on. When this occurs, the low voltage relay 54 activates which closes the contactor 60 and activates the mains powered relay 56 which turns on the switched mains power feeds 62 & 64. The mains switched power 46 in FIG. 3 is provided from the switched power feed 62 and 64 in FIG. 4.

Whilst the above description talked about the controller coupled to an alarm system it may in fact be controlled by many other parameters, including timing circuits and so on. It is to be made clear that the reason why the controller may switch the power off from one of the two circuits will be decided upon by the end user.

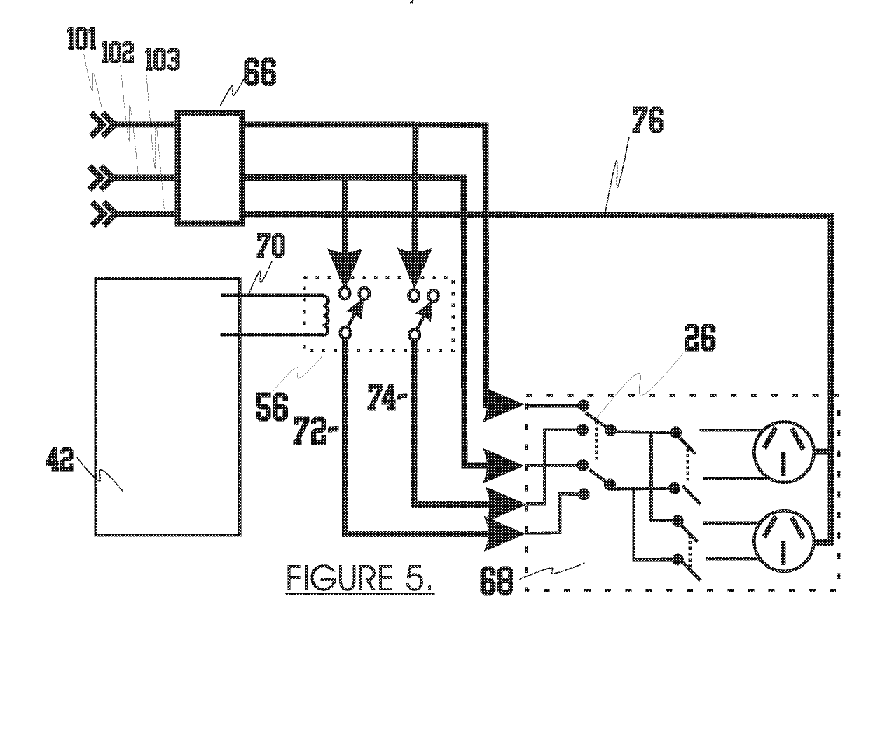

FIG. 5 illustrates in more detail how the invention works. Mains power is supplied from the switch board with the active wire 101, neutral wire 102 and earth wire 103 fed through a residual current device (RCD) 66 directly to GPO's 68 as well as to a relay 70 that provides a switched mains power source 72 and 74 to GPO's 68. One should note that the earth 76 is a common cable to both circuits. The RCD 66 is typically located in the switch board (not shown).

GPO 68 is one of many GPO's located throughout the building. The controller 42 is normally located near the switch board and turns on and off the power saver mains feed to the GPO when appropriate. For example the controller could be similar to the design as described in FIG. 4 or it could have a more complex design if required. Many buildings will have more than one circuit breaker for the GPO's, therefore if two circuits were required then this would mean that a second relay would also be required.

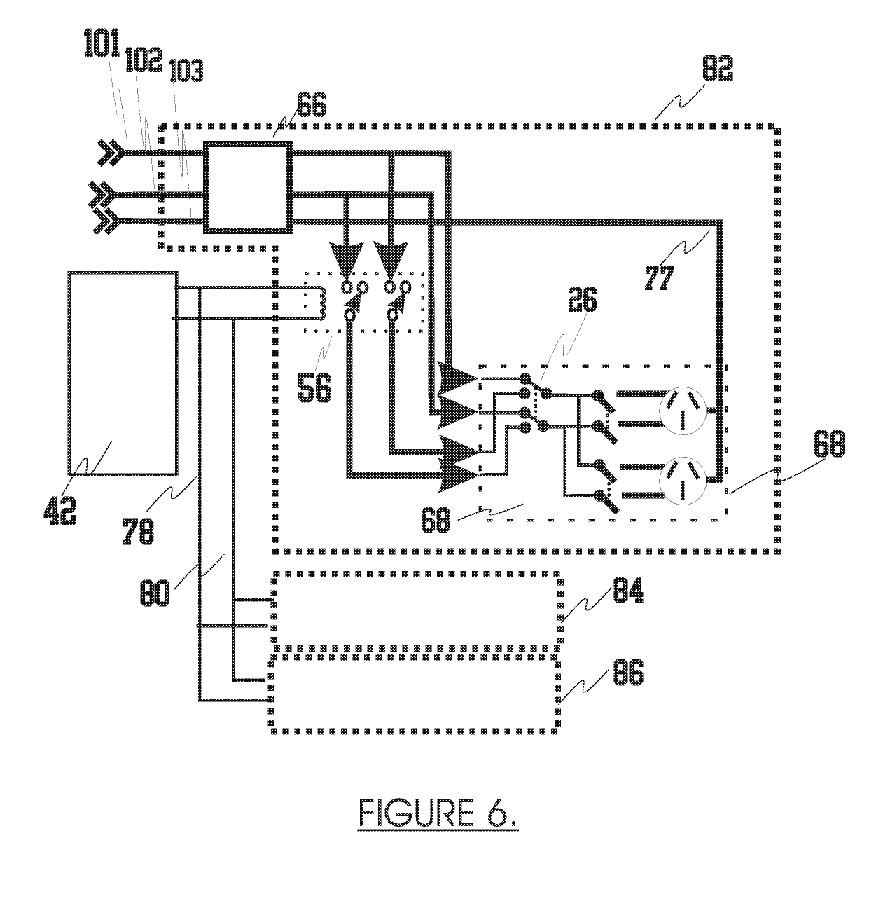

FIG. 6 is partially the circuit as in FIG. 5 but with provisions for multiple circuits. In many applications there may be many circuits required for powering the GPO's in a building, therefore each circuit would need its own circuit breaker and probably power feed. For example power feeds 78 and 80 from the controller 42 would operate many relays in different circuits here being illustrated three circuits 82, 84 and 86 respectively, circuit 82 represented in FIG. 5.

The limit to the number of relays is typically related to the power that the controller is capable of providing to power the relays on, but in practical terms the controller could power several relays since a relay typically does not draw a lot of current. If more relays were required then one relay could be configured to operate a second relay and so forth.

Lighting is typically on its own circuit and if lights are left on while a building is unoccupied they can consume a lot more power than the appliance that uses standby power. So if it was desirable to turn of certain circuits which power lighting then one of the circuits as described in FIG. 6 could be a lighting circuit which would turn off when the building is not in use. If the design of the building required certain lights left on while the building is unoccupied for (i.e. for security reasons) then those lights could be placed on a circuit which does not have the power saver relay. This would mean that the circuit would always be powered on.

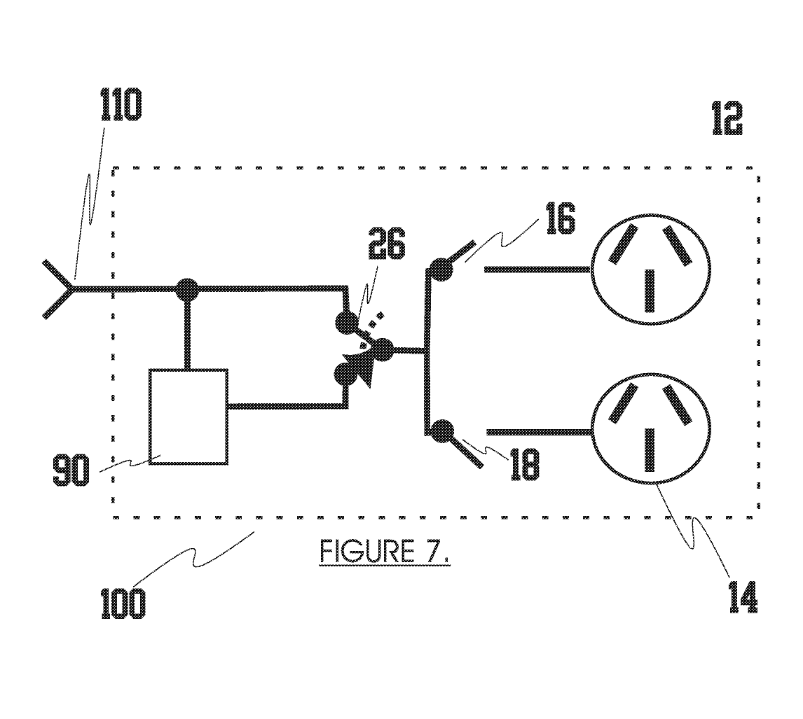

FIG. 7 illustrates a further embodiment of the invention in which a GPO 100 operates with a single power supply feed 30, but still achieves the same functionality as the first embodiment. This GPO can be retro fitted to any existing circuit where there is only a single power feed. The mains power in 30 is controllably switched by a circuit control and relay 90 to the selector switch 26. The circuit control and relay 90 is controlled remotely from the controller 42 which selects to either connect or disconnect the power supply in 30 to the selector switch 26. The circuit control and relay 90 is controlled via a wireless signal, or mains borne control signal, as is known in the prior art. The selector switch 26 can be switched as per the first embodiment to either a “power save” mode or “power always on” mode. In “power always on” mode, the outlets 12 and 14 are connected directly to the mains power in 30. In “power save” mode the outlets 12 and 14 are connected to the circuit control and relay 90 output. The outlets 12 and 14 are further controlled by switches 16 and 18 as in a conventional GPO.

The part of the system, or indeed a whole system, that incorporates GPOs as per the second embodiment does not require the switched mains power cable 46 as shown in FIG. 3. This can lead to installation cost savings, which could outweigh the extra costs of the GPOs. A further advantage in such a system is that the GPOs could be individually controllable, leading to more versatile control options.

In summary the invention described here illustrates embodiments of a GPO with a mains power selector to allow selection of each GPO's power source to be either always active or active only when the controller activates it. This simple method allows the building to turn off unneeded appliances while the building is unoccupied or not in use.

This can provide up to 10% in power saving in many houses by turning off appliances which use standby power but are not required to be on while the building is not being used.

However it is not intended to limit the invention to this type of operation. The controller could for example operate on a timer so that a circuit is powered up every few minutes per hour or a few hours per day. This may be used in examples where an appliance that runs on batteries needs to be recharged or even to other uses such as fish tanks where a tank needs to be oxygenated say 5 minutes every hour. Another use could be where the system is intelligent enough for example, to know the instant price of electrical power. Thus if the power cost per unit exceeds a predetermined value, the controller could disconnect the circuit from mains power and say come back on after one hour when the power price has hopefully gone down.

Further improvements may very well be made including having a separate power saver switch for each individual power outlet point rather than the whole GPO. In addition the switch could be remotely operated by the use of well known electrical 25 components such as solenoids, rather then being a simple user flick switch.

In other improvements the controller could in fact control both of the power supplies even with the mains power thus being able to be controlled. This may occur, for example, if there is a fire in the building where separate sensors immediately shut the power down through both circuits.

For the purposes of the specification the word “comprising” means “including but not limited to”, and the word “comprises” has a corresponding meaning. Also a reference within the specification to document or to prior use is not to be taken as an admission that the disclosure therein constitutes common general knowledge in Australia.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

What is claimed:

1. An electrical supply system including an electrical power point having at least one power outlet that is selectably connected to at least two power providing circuits, the power point including a selector means that is operable to provide the power to said at least one power outlet from one of the at least two power providing circuits, said system further including a controller that controls when power is supplied to one of the two circuits based upon pre-determined criteria.

2. An electrical power point having at least one power outlet that is selectably connected to at least two power providing circuits, the power point including a selector means that is operable to provide the power to said at least one power outlet from one of the at least two power providing circuits.

3. An electrical power point as in claim 2 further including a power outlet control switch to turn off the power supplied to said at least one power outlet.

4. An electrical power point having two parallel power outlets, both said power outlets fed power from a first or a second power providing circuit depending on the position of a selector switch, the switch in the first position feeding power to the outlets from said first power providing circuit and in a second position feeding power to the outlets from said second power providing circuit.

5. An electrical supply system for providing electrical supply from a first power providing circuit or a second power providing circuit, including:
a user operated selector switch operable between a first position for connecting a power outlet to the first power providing circuit, and a second position for connecting the power outlet to the second power providing circuit.

6. An electrical supply system including:
a first power providing circuit connected to a first mains electrical supply;
a second power providing circuit connected to a second mains electrical supply;
a user operated first circuit switch operable between a first position for connecting the first mains electrical supply to the first power providing circuit, and a second position for disconnecting the first mains electrical supply from the first power providing circuit;
at least one power outlet, and;
a user operated selector switch operable between a first position for connecting said at least one power outlet to the first power providing circuit, and a second position for connecting said at least one power outlet to the second power providing circuit.

7. An electrical supply system including:
a first power providing circuit connected to a mains electrical supply;
a second power providing circuit connected to said mains electrical supply via a relay;
a user operated first circuit switch operable between a first position for connecting the first mains electrical supply to the first power providing circuit, and a second position for disconnecting the first mains electrical supply from the first power providing circuit;
at least one power outlet, and;
a user operated selector switch operable between a first position for connecting said at least one power outlet to the first power providing circuit, and a second position for connecting said at least one power outlet to the second power providing circuit.

8. The electrical supply system of claim 7, wherein said relay is operable through a wireless or mains borne signal.
